(19) United States
(12) Patent Application Publication
(10) Pub. No.: US 2026/0194083 A1
(43) Pub. Date: Jul. 9, 2026

(54) SYSTEMS FOR AND METHODS OF PREPARING LOOSEFILL INSULATION MATERIAL

(71) Applicant: CERTAINTEED LLC, Malvern, PA (US)

(72) Inventor: Pierre LOMBARD, Malvern, PA (US)

(21) Appl. No.: 19/426,179

(22) Filed: Dec. 19, 2025

Related U.S. Application Data
(60) Provisional application No. 63/737,058, filed on Dec. 20, 2024.

(51) Int. Cl. F15D 1/02; E04B 1/76; F16L 59/04

(52) U.S. Cl. CPC F15D 1/02; E04B 1/7604; F16L 59/04

(57) ABSTRACT

A connector for opening insulation fiber is disclosed. The connector can include an inlet, an outlet, and a middle component between the inlet and outlet. The middle component can direct a first part of an air stream from the inlet to the outlet and a second part of an air stream at an angle between 10 degrees and 85 degrees towards the first part of the air flow to open fibrous flakes.

### CROSS-REFERENCE TO RELATED APPLICATION(S)

This Application claims priority under 35 U.S.C. § 119(e) to U.S. Provisional Patent Application No. 63/737,058 , entitled “SYSTEMS FOR AND METHODS OF PREPARING LOOSEFILL INSULATION MATERIAL,” filed Dec. 20, 2024, by Pierre LOMBARD, which is assigned to the current assignee hereof and is incorporated herein by reference in its entirety.

### BACKGROUND

### Field of the Disclosure

The present disclosure relates generally to loosefill insulation material for insulating buildings and, more specifically, to the conditioning of loosefill insulation during application thereof.

### Technical Background

Loosefill insulation disposed into an insulation cavity of walls, attic floors and other building structures provides numerous advantages to the buildings, including excellent coverage, thermal efficiency, moisture resistance, and ease of installation. The advantages of loosefill insulation are especially prominent for use in irregularly shaped areas, and around obstructions.

Loosefill insulation material, made of organic or inorganic fibers like glass fibers, is typically compressed and encapsulated in bags during storage and shipment. When removed from the packages, the insulation material separates into clumps. In order to effectively install the insulation material for its desired performance, it must first be “fluffed up” or conditioned to reduce its density and increase the volume of air around each fiber. The conditioning process breaks up the clumps and “opens up” the fibers of the insulation material. Traditionally, pneumatic devices, like blowing machines, are used to both install in the insulation and perform the conditioning. After the insulation material leaves the pneumatic device, it is then delivered and applied to the insulation area through means including a hose.

However, if the insulation is not sufficiently conditioned when it leaves the pneumatic device, it may not have the specified density for its desired thermal performance. Often the speed of the fibers may be changed to help open the fibers and produce better thermal and coverage performance. However, by changing the speed, the arc length is also affected causing installation difficulties and affecting the density of the fibers.

Accordingly, there remains a need to develop a system that increases conditioning of loosefill insulation material while maintaining a suitable speed for fibers so that the arc length of loosefill insulation material is applicable for its general use.

### SUMMARY

According to one embodiment, a connector for opening insulation fiber is disclosed. The connector can include an inlet, an outlet, and a middle component between the inlet and outlet, wherein the middle component directs a first part of an air stream from the inlet to the outlet and a second part of an air stream at an angle of at least 45 degrees towards the first part of the air flow to open fibrous flakes.

According to a further embodiment, a system for opening fibrous flakes is disclosed. The system can include a generator to produce an airstream, a hose comprising an inlet and an outlet, a plurality of fibrous flakes, wherein the plurality of fibrous flakes are moved through the inlet and the outlet of the hose by the air stream; and a connector in contact with to the hose. The connector can include an inlet, an outlet, and a middle component between the inlet and outlet, wherein the middle component directs a first part of an air stream from the inlet to the outlet and a second part of an air stream at an angle of at least 45 degrees towards the first part of the air flow to open fibrous flakes.

According to one embodiment, a method for opening fibrous flakes is disclosed. The method can include expelling an airstream with a plurality of fibrous flakes from an inlet of a connector through a middle component to an outlet of the connector, wherein the middle component directs a first part of an air stream from the inlet to the outlet and a second part of an air stream at an angle of at least 45 degrees towards the first part of the air flow to open fibrous flakes.

### BRIEF DESCRIPTION OF THE DRAWINGS

The present disclosure may be better understood, and its numerous features and advantages made apparent to those skilled in the art by referencing the accompanying drawings.

FIG. 1 includes a connector for opening insulation fiber, according to one embodiment of the disclosure.

FIGS. 2a and 2b each include a cross-sectional view of a connector, according to one or more embodiments of the disclosure.

FIG. 3 includes a cross-sectional view air flow through the connector of FIG. 1, according to one embodiment of the disclosure.

FIGS. 4A and 4B each include a system for opening fibrous flakes utilizing the connector of FIG. 1, according to one or more embodiments of the disclosure.

FIG. 5 includes an illustration of arc length as the fibrous flakes are being blown during installation, according to one embodiment.

FIG. 6 shows Table 1, the air speed at the center of a connector vs the air speed of a system that does not utilize a connector and measured within the distal end of a hose.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. The drawings are not necessarily to scale, and sizes of various elements may be distorted for clarity. The drawings illustrate one or more embodiment(s) of the disclosure and together with the description serve to explain the principles and operation of the disclosure.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The use of the word “about,” “approximately,” or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the construction products arts.

Various embodiments of the present disclosure will now be described, by way of example only, with reference to the accompanying drawings.

The present disclosure relates to a connector for opening fibrous flakes of loosefill insulation. The connector facilitates the opening of flakes by reducing the arc length ensuring that sufficient coverage is still achieved. The connector can include one or more curves to direct the air flow in a first direction forward from the inlet to the outlet and in a second direction to contact the air flow in the first direction at an angle of at least 45 degrees.

As one of skill in the art will appreciate, there can be varying materials that may be included as part of the loosefill insulation. These materials can include, but are not limited to, fiberglass, silicate glass, borosilicate glass, alumiosilicate glass, and alumioborosilicate glass, stone wool, cellulose, natural fibers, cotton, polymer fibers, plastic fibers, mineral (rock or slag) wool, fireproofing materials, and other granular or fibrous materials. In another embodiment, the fibers can include at least one organic material selected from the group consisting of animal fibers, cellulose-containing vegetable fibers, cotton, rayon granulated cork, redwood wool, recycled, ground, or shredded newspaper fibers, polyester, other thermoplastic fibers, or any combination thereof. In another embodiment, the fibers comprise at least one inorganic material selected from the group consisting of perlite, fibrous potassium titanate, alumina-silica fibers, micro quartz fibers, opacified colloidal alumina, zirconia fibers, carbon fibers, basalt fibers, aramid fibers, granulated charcoal, graphite fibers, cement fibers, rock fibers, slag fibers, glass wool, rock wool, or any combination thereof. The loosefill insulation itself can be made using conventional methods, from a number of different materials, e.g., glass, rock or stone (e.g., basalt or diabase, or other volcanic or subvolcanic rock), an at least partially purified mineral, slag, or a mixture thereof. Typically, the mineral source is molten and formed into fibers, using any of a number of spinning, centrifugation, drawing, or other fiberizing processes. The fiberizing process can provide fibers of a desired length, or fibers can be chopped to a desired size.

The fibers of the loosefill insulation are desirably relatively fine, so as to provide materials that can be installed by blowing to provide a relatively high degree of insulation. In certain embodiments as otherwise described herein, the median diameter of the fibers of the loosefill insulation (i.e., taken for each fiber as the maximum distance across the fiber in a direction perpendicular to the length of the fiber) is no more than about 100 microns, e.g., no more than about 50 microns or even no more than about 20 microns. In one embodiment, the median length of the collection of fibers is no more than 500 mm, e.g., no more than 250 mm, or no more than 100 mm. In another embodiment, the fibers of the loosefill insulation can have a median diameter of at least 10 nm, such as at least 50 nm, or at least 100 nm.

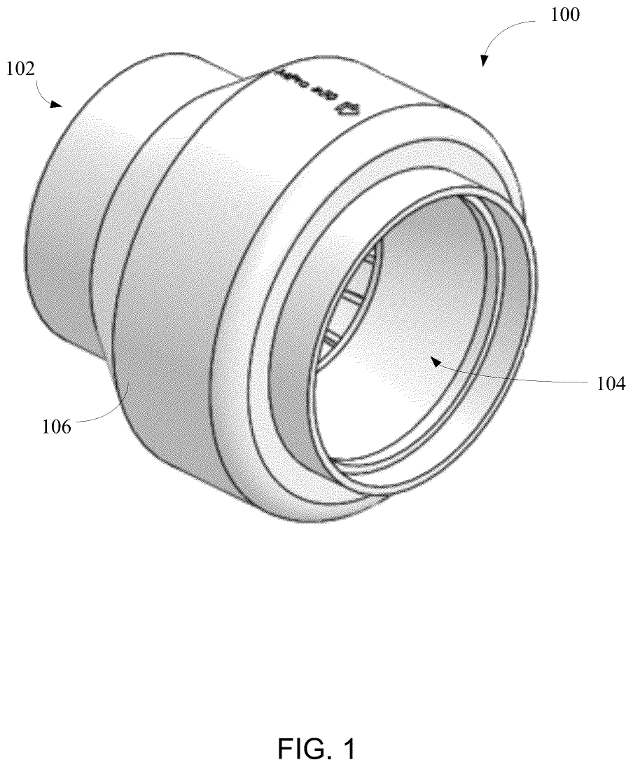

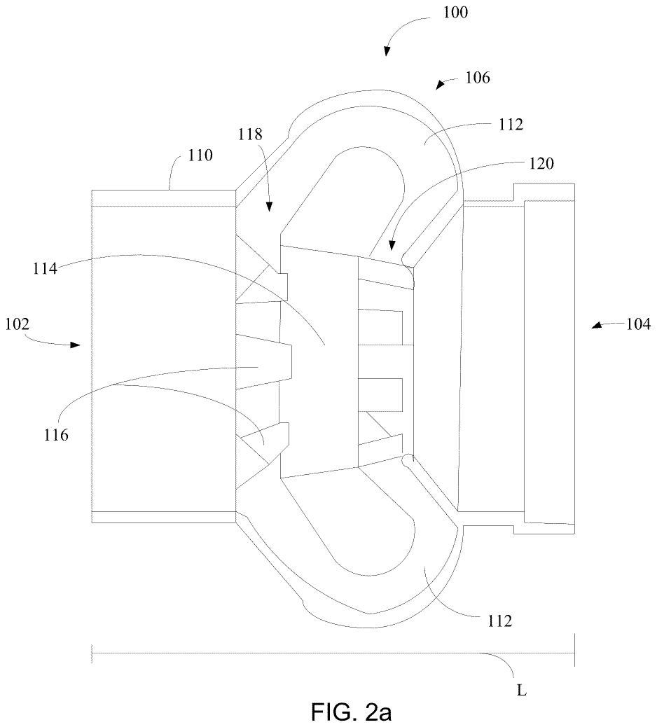

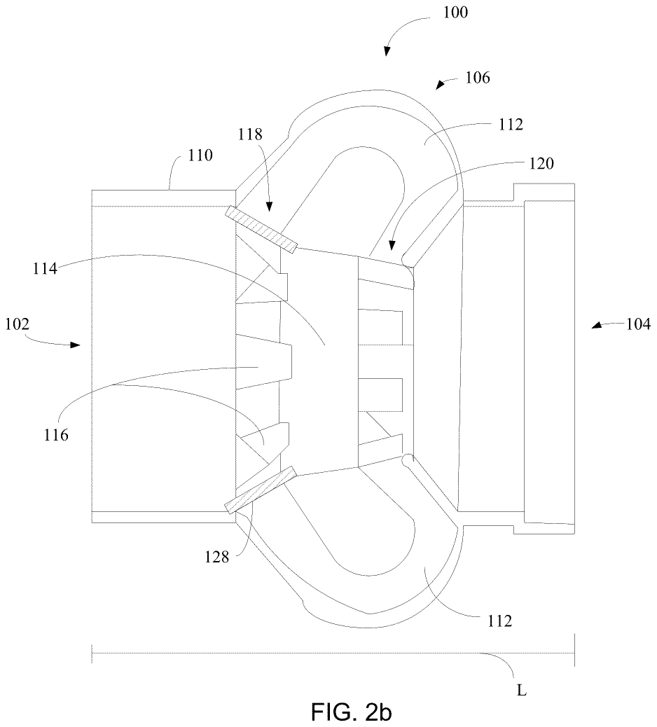

The loosefill insulation product can be installed using the connector and process as described herein. FIG. 1 includes a connector 100 for opening insulation fiber, according to one embodiment of the disclosure. FIGS. 2a and 2b each include a cut view of a connector 100, according to one embodiment of the disclosure. The connector 100 can include an inlet 102, an outlet 104, and a middle component 106. In one embodiment, the inlet 102 can be connected to a hose 408. As shown in FIG. 1, in one embodiment, the connector 100 can have a circular inlet 102 and a circular outlet 104. It can be imagined, however, that the inlet 102 can be oval, triangular, rectangular, polygonal, hexagonal, or square. It can be imagined that the outlet 104 can be oval, triangular, rectangular, polygonal, hexagonal, or square. In one embodiment, the outlet 104 can have the same shape as the inlet 102. In another embodiment, the outlet 104 can have a different shape from the inlet 102. In one embodiment, the inlet 102 can have approximately the same diameter as the outlet 104. In another embodiment, the inlet 102 can have a smaller diameter than the outlet 104. In another embodiment, the inlet 102 can have a larger diameter than the outlet 104.

The middle component 106 of the connector 100 can be between the inlet 102 and the outlet 104. In one embodiment, the middle component 106 can be equidistant from the inlet 102 and the outlet 104. In another embodiment, the middle component 106 can be closer to the inlet 102 than the outlet 104. In yet another embodiment, the middle component 106 can be closer to the outlet 104 than the inlet 102. The middle component 106 can have a larger diameter than the inlet 102. In another component the middle component 106 can have a larger diameter than the outlet 104. In one embodiment, the middle component 106 can have a length that is between 10% and 90% a total length L of the connector, where the length is measured as a distance from the inlet 102 to the outlet 104 of the connector. In one embodiment, the middle component 106 can have a length that is between 10% and 65% a total length L of the connector, where the length is measured as a distance from the inlet 102 to the outlet 104 of the connector. In one embodiment, the middle component 106 can have a length that is between 20% and 40% a total length L of the connector, where the length is measured as a distance from the inlet 102 to the outlet 104 of the connector.

In one embodiment, the middle component 106 can extend laterally out from a body 110 of the connector. The middle component 106 can include one or more channels. The one or more channels can be within an outer wall of the connector 100. In one embodiment, the middle component can include an internal channel 114 and one or more external channels 112. In one embodiment, the one or more external channels 112 can circumferentially surround the internal channel 114. In operation, the internal channel 114 can direct a first portion of an air stream forward from the inlet 102 to the outlet 104. The middle component 106 can include one or more structures 116 that separate the internal channel 114 from the one or more external channels 112. In one embodiment, the one or more structures 116 of the middle component are within the outer wall of the connector 100. The one or more external channels 112 can direct a second portion of the air stream in a different direction than the internal channel 114. In one embodiment, the one or more external channels 112 can include one or more twists. In one embodiment, the one or more external channels 112 can include one or more turns. In one embodiment, the one or more external channels 112 can include one or more loops. In one embodiment, the one or more external channels 112 can include a combination of one or more twists, turns, and loops. In one embodiment, the one or more external channels 112 can include one or more turns in one or more directions. In another embodiment, the one or more external channels 112 can include one or more turns on different axis. In one embodiment, the one or more external channels 112 can include one or more spirals. In one embodiment, the airstream exiting the outlet 120 can have an angle that is not normal to the flow of the airstream in the internal channel 114. In other words, the airstream exiting the outlet 120 can have an angles between 10 degrees and 85 degrees as measured clockwise to the opening of the inlet 102 of the connector 100. In one embodiment, the one or more external channels 112 can have one or more inlets 118 and one or more outlets 120, with each respective external channel 112 having an inlet 118 and an outlet 120. In one embodiment, the inlet 118 of the exterior channel 106 can have a diameter that is smaller than the diameter of the inlet 102 of the connector 100. While the term diameter is used herein, it should be understood that with varying geometries, such as square connectors, hexagonal connectors, or rectangular connectors, the cross-sectional equivalent diameter is measured by a line passing through the center of the connector in cross-section and reaching the opposite farthest point of the cross-section. In one embodiment, the outlet 120 of the exterior channel 106 can have a diameter that is smaller than the diameter of the inlet 102 of the connector 100. In one embodiment, the inlet 118 of the exterior channel 106 can have a diameter that is smaller than the diameter of the outlet 104 of the connector 100. In one embodiment, the outlet 120 of the exterior channel 106 can have a diameter that is smaller than the diameter of the outlet 104 of the connector 100.

In one embodiment, a filter 128 can span across the opening of the inlet 118, as shown in FIG. 2b. The filter 128 can prevent the loosefill insulation from entering the exterior channel 106. In one embodiment, loosefill insulation can only move from the inlet 102 through the interior channel 114 and through the outlet 104 while the airstream can move from the inlet 102 through either or both the interior channel 114 and the one or more external channels 112 and through the outlet 104.

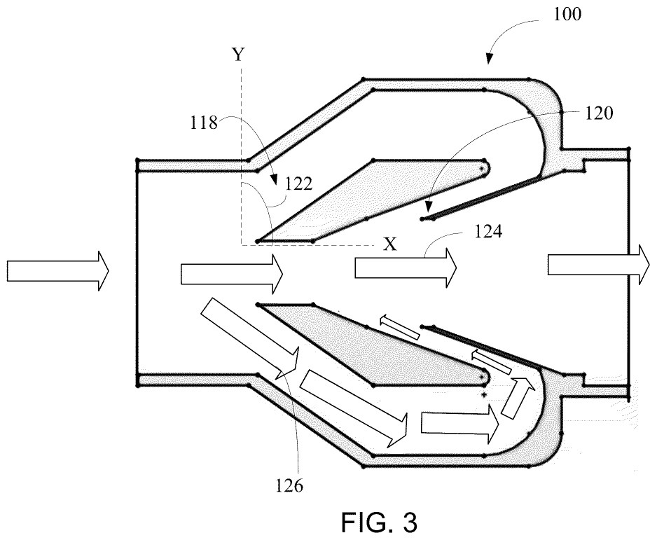

In one embodiment, the inlet 118 can be at an angle 122 of between 0 degrees and 90 degrees as measured perpendicular and clockwise to the opening of the inlet 102 of the connector 100, as seen in FIG. 3. As shown in FIG. 3, the y-axis is 0 degrees and the x-axis is 90 degrees. In one embodiment, the angle 122 of the inlet 118 can be 10 degrees, 15 degrees, 20 degrees, 25 degrees, 30 degrees, 45 degrees, 60 degrees, or 80 degrees. In one embodiment, the outlet 120 can be at an angle of between 0 degrees and 90 degrees as measured perpendicular and clockwise to the opening of the inlet 102 of the connector 100. In one embodiment, the angle of the outlet 120 can be 10 degrees, 15 degrees, 20 degrees, 25 degrees, 30 degrees, 45 degrees, 60 degrees, or 80 degrees. In one embodiment, the inlet 118 and the outlet 120 can have the same angle. In another embodiment, the inlet 118 and the outlet 120 can have a different angle. In one embodiment, the angle of the inlet 118 and the outlet 120 can include non-integer numbers. It has been discovered that when the angle of the outlet 120 is +/− within 5 degrees of 0 degrees, the flow of the airstream shears the fibers so that they become unusable. It has also been discovered that when the angle of the outlet 120 is +/− within 2 degrees of 90 degrees, the flow of the airstream can become blocked and negatively affect the airstream.

FIG. 3 includes a cross-sectional view air flow through the connector 100 of FIG. 1, according to one embodiment of the disclosure. In operation, an airstream can flow from a hose 408 to the connector 100. In one embodiment, the airstream can contain loosefill insulation. The airstream can move from the hose 408 to the inlet 102 of the connector 100. Once inside the connector 100, the airstream can be divided into multiple paths. The connector can direct the airstream in a first path or direction 124 through the interior channel 114 of the connector 100. The first path 124 can be perpendicular to the opening of the inlet 102. The airstream on the first path or direction 124 can move from the inlet 102, through the middle component 106, and to the outlet 104 without changing direction. The connector can direct the airstream in a second path or direction 126 through the one or more exterior channels 116. In another embodiment, the connector can direct a first portion of the airstream in the first path or direction 124 through the interior channel 114 of the connector 100 and a second portion of the airstream in the second path or direction 126 through the one or more exterior channels 116.

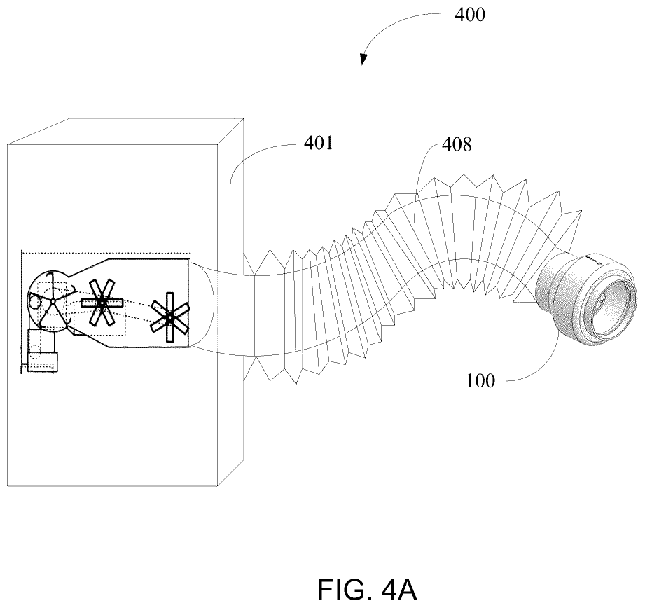

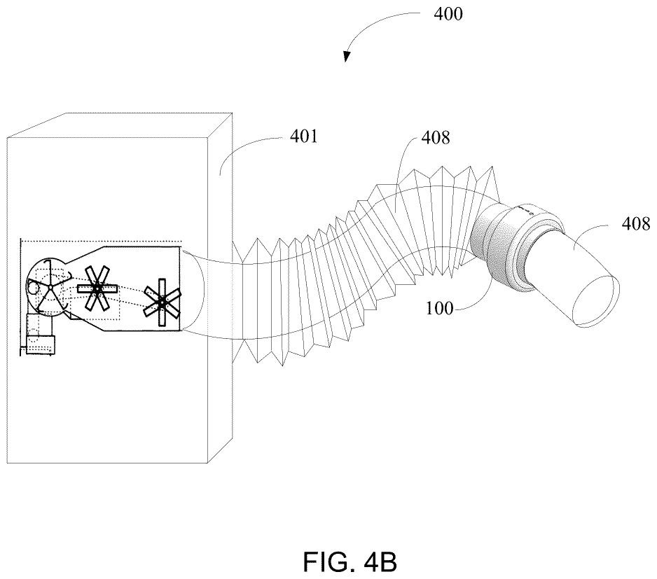

In one embodiment, a portion of the airstream on the first path or direction 124 can move from the inlet 102, through the middle component 106, and to the outlet 104 while maintaining within +/−5 degrees of its original angle upon entry from the inlet 102. In another embodiment, a portion of the airstream on the first path or direction 124 can move from the inlet 102 towards the middle component 106 and interact with a portion of the airstream on the second path or direction 126. In one embodiment, a portion of the airstream on the second path or direction 126 can move from the inlet 102 and change angles as it moves into the one or more exterior channels 112. The airstream that enters the one or more exterior channels 112 can change speed. In one embodiment, the speed of the airstream that exits through the outlet 120 of the one or more exterior channels 112 can be more than the speed of the airstream in the first path or direction 124. In one embodiment, the speed of the of the airstream that exits through the outlet 120 of the one or more exterior channels 112 can be between 5% and 35% greater than the speed of the airstream in the first path or direction 124. The speed of the airstream can be affected by the diameter of the inlet or outlet; by decreasing the diameter, the speed of the airflow increases and by increasing the diameter of the inlet or outlet, the speed of the airflow decreases. As such, given a 4 inch diameter inlet and outlet, the speed of the airflow can be at least 3000 ft/min upon exiting the outlet 104 of the connector. In one embodiment, the airspeed of a system, as described below with respect to FIG. 4, that utilizes a connector 100 can be greater than 4100 ft./min., such as greater than 5000 ft./min., such as greater than 6000 ft./min., or greater than 8000 ft./min.

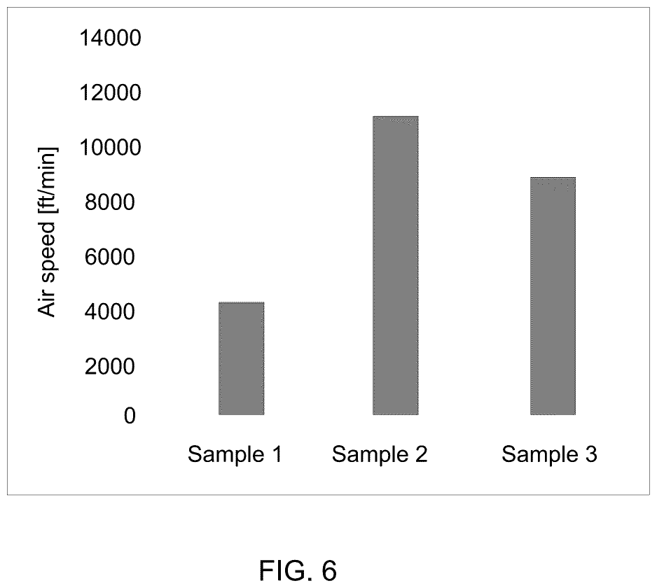

FIG. 6 shows Table 1, the air speed at the center of a connector vs the air speed of a system that does not utilize a connector and measured within the distal end of a hose.

The airstream speed was measured using a pitot tube and Bernoulli's equation. Sample 1 was a system that did not utilize a connector. Sample 2 was a system that utilized a connector with no external channels that increased air speed. Sample 3 was a system that utilized a connector with external channels, as described above, in conjunction with a connector with no external channels. Sample 1 had an airspeed of less than 4100 ft./min. Samples 2 and 3 had an airspeed of greater than 4100 ft./min., such as greater than 5000 ft./min., such as greater than 6000 ft./min., or greater than 8000 ft./min. Sample 3 has an airspeed of less than 11000 ft./min, such as less than 10000 ft./min.

In one embodiment, airstream that exits through the outlet 120 of the one or more exterior channels 112 can interact with the airstream that was on the first path and was directed through the internal channel 114 and cause the fibers of the loosefill insulation to open and increase the air to fiber ratio. In one embodiment, airstream that exits through the outlet 120 of the one or more exterior channels 112 can interact with the airstream that was on the first path and was directed through the internal channel 114 and cause a turbulent flow. In one embodiment, airstream that exits through the outlet 120 of the one or more exterior channels 112 can interact with the airstream that was on the first path and was directed through the internal channel 114 and cause a decrease in the speed of the airstream that exits the outlet 104 by between 10% and 25%, as compared to the speed of the airstream that enters the inlet 102. In other words, the speed of the airstream as it exits the outlet 104 can be between 10% and 25% slower than the speed of the airstream as it enters the inlet 102.

The connector 100 can be a part of a system used to blow insulation. FIGS. 4A and 4B each include a system 400 for opening fibrous flakes utilizing the connector 100 of FIG. 1, according to one embodiment of the disclosure. The system 400 can include a generator 401, a hose 408, a plurality of fibrous flakes or insulation, and a connector 100. The generator 401 can be a blowing machine or an air compressor or any other machine for distributing insulation. The generator 401 can produce an airstream for the system 400. In one embodiment, the generator can include a chute having an inlet end and an outlet end, the chute being configured to receive a bag of compressed insulation. In one embodiment, the generator 401 can include a shredder mounted at the outlet end of the chute and configured to shred and pick apart the insulation. The generator 401 can also include a discharge mechanism which distributes the insulation into an airstream. As it will be understood by those of skill in the art, more than one connector 100 can be installed between the one or more hose sections. Also, in such embodiments, the more than one connectors 100 may be connected directly in series one to another without intervening sections of hose between the two or more connectors. In another embodiment, the more than one connectors 100 may be in series one to another with a section of hose between the two or more connectors.

In one embodiment, the hose 408 can connect to generator 401 and the connector 100. The hose 408 can include one or more sections. In one embodiment, the hose 408 can include a section before the connector 100 and a section after the connector 100, as seen in FIG. 4B. In one embodiment, the inlet 102 of the connector 100 can be connected to the hose 408. In other words, in one embodiment, the connector 100 can be at one end of the hose 408. In one embodiment, the connector 100 can be towards the distal end of the hose 408, where the loosefill insulation is being blown out of the system 400. In another embodiment, the connector 100 can be between any section of the hose 408, as seen in FIG. 4B. In one embodiment, the inlet 102 and the outlet 104 of the connector 100 can be connected to the hose 408. In one embodiment, the connector 100 can be within between 1 ft. and 5 ft. of the distal end of the hose 408, where the loosefill insulation is being blown out.

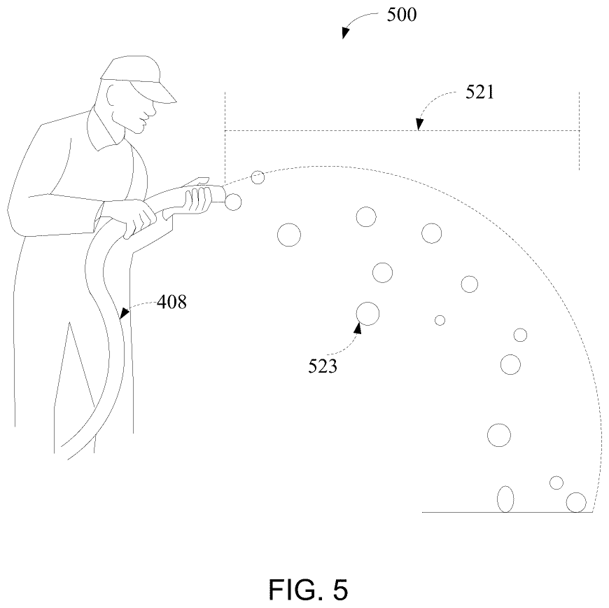

FIG. 5 includes an illustration of arc length as the fibrous flakes are being blown during installation 500, according to one embodiment. As can be seen in FIG. 5, during installation, the hose 408 connected to the connector 100 can blow fibrous flakes 523 into a space. The arc length 521 is measured from the point where the fibrous flakes 523 exit the hose 408 or connector 100 to the farthest point of installation. The flakes are blown into an open space and travel a distance until they reach the ground or other objects. The fibrous flakes 523 are blown until the fibrous flakes 523 settle into their final destination and no longer have a speed or trajectory. In one embodiment, the airstream exiting the connector 100 can have an arc length that is 2% to 45% shorter than an airstream exiting a hose without a connector. Advantageously, the system 400 can be utilized to increase the air to fiber ratio of the fibrous flakes while maintaining a shorter arc length than a system without a connector. In one embodiment, the air to fiber ratio can be between 1.2:1 to 4:1. In one embodiment, the air to fiber ratio is 3.5:1. In another embodiment, the air to fiber ratio is 3:1, such as 2.5:1, or such as 2:1, or such as 1.5:1, or such as 1.25:1. In one embodiment, the airstream exiting the connector 100 can have an arc length that is 3% to 35% shorter than an airstream exiting a hose without a connector, such as between 5% to 20% shorter or such as 10% and 15% shorter.

The connector described herein can advantageously be used to distribute as insulation materials in a variety of contexts, including insulation of building structures. Accordingly, the system 400 can be utilized to insulate a structure, the insulated structure having an interior surface (e.g., a surface of a wall, a ceiling, floor, an attic, a basement, or another building surface), where the plurality of loosefill insulation fibers can be disposed against the interior surface. In one embodiment, the insulated structure is house or industrial building.

Advantageously, by utilizing the connector as described herein, the loosefill fibrous flakes can be opened and increase the air to fiber ratio while maintaining a shorter arc length. Also, in conventional systems, often clumps of flakes can form as the insulation is not sufficiently broken apart. In a system that utilizes the connector as described, the flakes are relatively uniform without clumps.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Various Embodiments

Embodiment 1. A connector for opening insulation fiber is disclosed. The connector can include an inlet, an outlet, and a middle component between the inlet and outlet, where the middle component directs a first part of an air stream from the inlet to the outlet and a second part of an air stream at an angle of between 10 degrees and 85 degrees towards the first part of the air flow to open fibrous flakes.
Embodiment 2. The connector of embodiment 1, where the middle component directs a second part of the air stream from the inlet to the outlet in a direction perpendicular to an opening of the inlet.
Embodiment 3. The connector of embodiment 1, where the middle component can include one or more channels.
Embodiment 4. The connector of embodiment 3, where the one or more channels of the middle component affect the flow of the air stream.
Embodiment 5. The connector of embodiment 2, where the one or more channels can include an interior channel and an external channel.
Embodiment 6. The connector of embodiment 5, where the interior channel and the external channel are within an outer wall of the middle component.
Embodiment 7. The connector of embodiment 5, where the middle component further can include a structure that separates the interior channel from the external channel.
Embodiment 8. The connector of embodiment 6, where the structure is within an outer wall of the connector.
Embodiment 9. The connector of embodiment 1, where the middle component expands laterally outward from a body of the connector.
Embodiment 10. The connector of embodiment 8, where the middle component can include a length that is between 10% and 65% a total length of the connector.
Embodiment 11. The connector of embodiment 4, where the external channel circumferentially surrounds the interior channel.
Embodiment 12. The connector of embodiment 4, where the external channel can include one or more turns.
Embodiment 13. The connector of embodiment 4, where the external channel can include an outlet and an inlet.
Embodiment 14. The connector of embodiment 12, where the outlet of the external channel is at an angle of less than 90 degrees, measured clockwise from the direction perpendicular to the opening of the inlet.
Embodiment 15. The connector of embodiment 4, where the external channel can include a loop.
Embodiment 16. The connector of embodiment 4, where the external channel directs the first part of the air stream towards the interior channel.
Embodiment 17. The connector of embodiment 4, where the interior channel directs the first part of the air stream forward between the inlet and the outlet.
Embodiment 18. The connector of embodiment 1, where the airstream enters the connector from the inlet and exits the connector from the outlet.
Embodiment 19. The connector of embodiment 1, where the airstream comprises fibrous flakes.
Embodiment 20. The connector of embodiment 1, where the second part of the air stream does not comprise fibrous flakes.
Embodiment 21. The connector of embodiment 19, where the first part of the air stream comprises fibrous flakes.
Embodiment 22. The connector of embodiment 18, where the fibrous flakes can include fibers from the group consisting of animal fibers, cellulose-containing fibers, synthetic polymer fibers, rock wool fibers, mineral fibers, glass fibers, carbon fibers, cement fibers, graphite fibers, slag fibers, wood fibers, or any combination thereof.
Embodiment 23. The connector of embodiment 1, where the middle component can include an air filter.
Embodiment 24. The connector of embodiment 2, where the first part of the airstream collides with the second part of the airstream before exiting from the outlet.
Embodiment 25. The connector of embodiment 3, where the first part of the airstream joins the second part of the airstream at an angle of less than 90 degrees, measured clockwise from the direction of the inlet.
Embodiment 26. The connector of embodiment 8, where the external channel decreases a speed of the air stream by between 10% and 45% as it passes into the inlet of the external channel.
Embodiment 27. The connector of embodiment 5, where the second part of the air stream exits an outlet of the external channel at a higher speed than the speed of the first part of the air stream.
Embodiment 28. The connector of embodiment 1, where the airstream exiting the connector has an arc length that is 3% to 35% shorter than an airstream exiting a hose without a connector.
Embodiment 29. The connector of embodiment 1, where the airstream has a speed of more than 4000 ft/min. after exiting from the outlet.
Embodiment 30. The connector of embodiment 1, where both the inlet and the outlet directs the air stream in a forward direction.
Embodiment 31. A system for opening fibrous flakes is disclosed. The system can include a generator to produce an airstream, a hose comprising an inlet and an outlet; a plurality of fibrous flakes, where the plurality of fibrous flakes are moved through the inlet and the outlet of the hose by the air stream; and a connector connected to the hose. The connector can include an inlet, an outlet, and a middle component between the inlet and outlet, where the middle component directs a first part of an air stream from the inlet to the outlet and a second part of an air stream at an angle of at least 45 degrees towards the first part of the air flow to open fiber flakes.
Embodiment 32. The system of embodiment 31, where the airstream enters the connector from the inlet and exits the connector from the outlet.
Embodiment 33. The system of embodiment 31, where the middle component directs a second part of the air stream flow forward.
Embodiment 34. The system of embodiment 31, where the middle component comprises one or more channels.
Embodiment 35. The system of embodiment 34, where the one or more channels of the middle component affect the flow of the air stream.
Embodiment 36. The system of embodiment 33, where the middle component comprises an interior channel and an external channel.
Embodiment 37. The system of embodiment 36, where the external channel surrounds the interior channel.
Embodiment 38. The system of embodiment 36, where the external channel comprises one or more turns.
Embodiment 39. The system of embodiment 36, where the external channel comprises an outlet and an inlet.
Embodiment 40. The system of embodiment 39, where the outlet of the external channel is at an angle of less than 90 degrees, measured clockwise from the direction of the inlet of the external channel.
Embodiment 41. The system of embodiment 36, where the external channel comprises a loop.
Embodiment 42. The system of embodiment 36, where the external channel directs the first part of the air stream backwards towards the interior channel.
Embodiment 43. The system of embodiment 36, where the interior channel directs the second part of the air stream flow forward.
Embodiment 44. The system of embodiment 31, where the airstream enters the connector from the inlet and exits the connector from the outlet.
Embodiment 45. The system of embodiment 31, where the airstream comprises fibrous flakes.
Embodiment 46. The system of embodiment 31, where the first part of the air stream does not comprise fibrous flakes.
Embodiment 47. The system of embodiment 33, where the second part of the air stream comprises fibrous flakes.
Embodiment 48. The system of embodiment 45, where the fibrous flakes comprise fibers from the group consisting of animal fibers, cellulose-containing fibers, synthetic polymer fibers, rock wool fibers, glass fibers, carbon fibers, cement fibers, graphite fibers, slag fibers, or any combination thereof.
Embodiment 49. The system of embodiment 31, where the middle component comprises an air filter.
Embodiment 50. The system of embodiment 33, where the first part of the airstream collides with the second part of the airstream before exiting from the outlet.
Embodiment 51. The system of embodiment 36, where the first part of the airstream joins the second part of the airstream at an angle of less than 90 degrees, measured clockwise from the direction of the inlet.
Embodiment 52. The system of embodiment 37, where a speed of the airstream as passes the outlet of the external channel is greater than a speed of the airstream through the first interior channel.
Embodiment 53. The system of embodiment 36, where the second part of the air stream has an increased speed before collision with the first part of the air stream.
Embodiment 54. The system of embodiment 34, where the second part of the air stream has an increased speed by 10% to 35% percent before collision with the first part of the air stream.
Embodiment 55. The system of embodiment 31, where the airstream exiting the connector has an arc length that is 3% to 35% shorter than an airstream exiting a hose without a connector.
Embodiment 56. The system of embodiment 31, where a speed of the airstream through the outlet of the connector has a reduced speed of between 10% and 45% of a speed of the airstream at the inlet of the connector.
Embodiment 57. The system of embodiment 31, where more than one connector is used.
Embodiment 58. The system of embodiment 57, where the more than one connector are connected in series.
Embodiment 59. The system of embodiment 58, where there is no hose in between the more than one connector in series.
Embodiment 60. A method for opening fibrous flakes is disclosed. The method can include expelling an airstream with a plurality of fibrous flakes from an inlet of a connector, where the middle component directs a first part of an air stream from the inlet to the outlet and a second part of an air stream at an angle of between 10 degrees and 85 degrees towards the first part of the air stream to open fibrous flakes.
Embodiment 61. The method for opening fibrous flakes of embodiment 60, where the middle component directs a second part of the air stream flow forward.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A connector for opening insulation fiber, comprising:
an inlet,
an outlet, and
a middle component between the inlet and outlet, wherein the middle component directs a first part of an air stream from the inlet to the outlet and a second part of an air stream at an angle between 10 degrees and 85 degrees towards the first part of the air stream to open fibrous flakes.

2. The connector of claim 1, wherein the middle component directs a second part of the air stream from the inlet to the outlet in a direction perpendicular to an opening of the inlet.

3. The connector of claim 1, wherein the middle component comprises one or more channels.

4. The connector of claim 3, wherein the one or more channels of the middle component affect the flow of the air stream.

5. The connector of claim 2, wherein the one or more channels comprises an interior channel and an external channel.

6. The connector of claim 5, wherein the interior channel and the external channel are within an outer wall of the middle component.

7. The connector of claim 5, wherein the middle component further comprises a structure that separates the interior channel from the external channel.

8. The connector of claim 6, wherein the structure is within an outer wall of the connector.

9. The connector of claim 1, wherein the middle component expands laterally outward from a body of the connector.

10. The connector of claim 4, wherein the external channel circumferentially surrounds the interior channel.

11. The connector of claim 4, wherein the external channel comprises one or more turns.

12. The connector of claim 4, wherein the external channel comprises an outlet and an inlet.

13. The connector of claim 12, wherein the outlet of the external channel is at an angle of less than 90 degrees, measured clockwise from the direction perpendicular to the opening of the inlet.

14. The connector of claim 4, wherein the external channel comprises a loop.

15. The connector of claim 4, wherein the external channel directs the first part of the air stream towards the interior channel.

16. The connector of claim 1, wherein the airstream comprises fibrous flakes, and wherein the fibrous flakes comprise fibers from the group consisting of animal fibers, cellulose-containing fibers, synthetic polymer fibers, rock wool fibers, mineral fibers, glass fibers, carbon fibers, cement fibers, graphite fibers, slag fibers, wood fibers, or any combination thereof.

17. The connector of claim 1, wherein the middle component comprises an air filter.

18. A system for opening fibrous flakes comprising:
a generator to produce an airstream;
a hose comprising an inlet and an outlet;
a plurality of fibrous flakes, wherein the plurality of fibrous flakes are moved through the inlet and the outlet of the hose by the air stream; and
a connector connected to the hose, wherein the connector comprises:
an inlet,
an outlet, and
a middle component between the inlet and outlet, wherein the middle component directs a first part of an air stream from the inlet to the outlet and a second part of an air stream at an angle of at least 45 degrees towards the first part of the air flow to open fiber flakes.

19. A method for opening fibrous flakes, comprising,
expelling an airstream with a plurality of fibrous flakes from an inlet of a connector,
wherein the middle component directs a first part of an air stream from the inlet to the outlet and a second part of an air stream at an angle of between 10 degrees and 85 degrees towards the first part of the air stream to open fibrous flakes.

20. The method for opening fibrous flakes of claim 19, wherein the middle component directs a second part of the air stream flow forward.
